(19) United States
(12) Patent Application Publication
(10) Pub. No.: US 2014/0026409 A1
(43) Pub. Date: Jan. 30, 2014

(54) Bar Connecting Apparatus and a String of Clips Usable Therewith

(71) Applicant: Basso Industry Corp., Taichung (TW)

(72) Inventors: An-Gi Liu, Taichung (TW); Yuan-Chi Chiang, Taichung (TW)

(73) Assignee: BASSO INDUSTRY CORP., Taichung (TW)

(21) Appl. No.: 13/950,792

(22) Filed: Jul. 25, 2013

(30) Foreign Application Priority Data
Jul. 30, 2012 (TW) 101127450

(51) Int. Cl. B25B 31/00; F16B 7/04

(52) U.S. Cl. CPC B25B 31/00; F16B 7/0493
USPC 29/811.2; 411/442

(57) ABSTRACT

A bar connecting apparatus is used for firing a string of clips one at a time to connect two intersecting bars together. The bar connecting apparatus includes: a main body having a front end portion formed with an ejection opening; a driving unit including a hammer disposed in the main body, and a drive disposed in the main body for reciprocating the hammer; and a magazine unit including a magazine connected to the main body and adapted for storing the clips, and a clip pushing device for pushing one of the clips into the ejection opening so that a portion of the one of the clips extends outwardly from the main body through the ejection opening.

### CROSS-REFERENCE TO RELATED APPLICATION

This application claims priority of Taiwanese Application No. 101127450, filed on Jul. 30, 2012.

### BACKGROUND OF THE INVENTION

1. Field of the Invention

This invention relates to a bar connecting apparatus, and more particularly to a bar connecting apparatus that applies clips to connect intersecting bars used in reinforced concrete.

2. Description of the Related Art

Referring to FIG. 1, a conventional bar connecting apparatus 1 disclosed in U.S. Pat. No. 7,891,074 is used to fire a string of clips 21. The bar connecting apparatus 1 includes a main body 11, a hammer 12 disposed in the main body 11 and driven pneumatically, and a clip feed assembly 13. The main body 11 has an ejection opening 111 formed at a front end portion 110 thereof and extending along an X-axis direction, and a clip track 112 extending through the clips 21 along a direction perpendicular to the X-axis direction. The clip feed assembly 13 includes two cam plates 131 disposed respectively and pivotally on two opposite sides of the main body 11, two zigzag cam tracks 132 in the form of slots and formed respectively in the cam plates 131, two cam guides 133 extending respectively through the cam tracks 132 and connected to the hammer 12, and two feed support blocks 134 connected respectively to the cam plates 131 for clamping the string.

Reciprocal movement of the hammer 12 along the X-axis direction results in firing of the terminal clip 21 and reciprocal movement of each of the cam guides 133 along a straight slot. Hence, the feed support blocks 134 move away from the ejection opening 111 in a direction perpendicular to the X-axis direction to hold the next clip 21. Subsequently, the feed support blocks 134 carry the string to move toward the ejection opening 111 in the direction perpendicular to the X-axis direction. In this manner, the clips 21 can advance successively into the ejection opening 111.

When the terminal clip 21 is to be fired, it is necessary to position the front end portion 110 of the main body 11 on the bars 22, 23 to ensure that the clip 21 can interconnect the crossed bars 22, 23 accurately.

However, since the hammer 12 is connected to the clip feed assembly 13, the volume of the conventional bar connecting apparatus 1 is relatively large. Furthermore, due to need for positioning the front end portion 110 of the main body 11 on the bars 22, 23 prior to firing, it is difficult to interconnect the bars 22, 23 accurately.

### SUMMARY OF THE INVENTION

The object of this invention is to provide a bar connecting apparatus that has a reduced volume and that can interconnect two intersecting bars accurately.

According to this invention, a bar connecting apparatus is used for firing a string of clips one at a time to connect two intersecting bars together. The bar connecting apparatus includes: a main body having a front end portion formed with an ejection opening; a driving unit including a hammer disposed in the main body, and a drive disposed in the main body for reciprocating the hammer; and a magazine unit including a magazine connected to the main body and adapted for storing the clips, and a clip pushing device for pushing one of the clips into the ejection opening so that a portion of the one of the clips extends outwardly from the main body through the ejection opening.

Since the magazine unit has the function of pushing the clips, the bar connecting apparatus can be designed to have a comparatively small volume. Furthermore, a portion of the terminal clip is exposed outwardly of the main body so as to assist in interconnecting the bars accurately.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a side view of a conventional bar connecting apparatus 1 disclosed in U.S. Pat. No. 7,891,074;

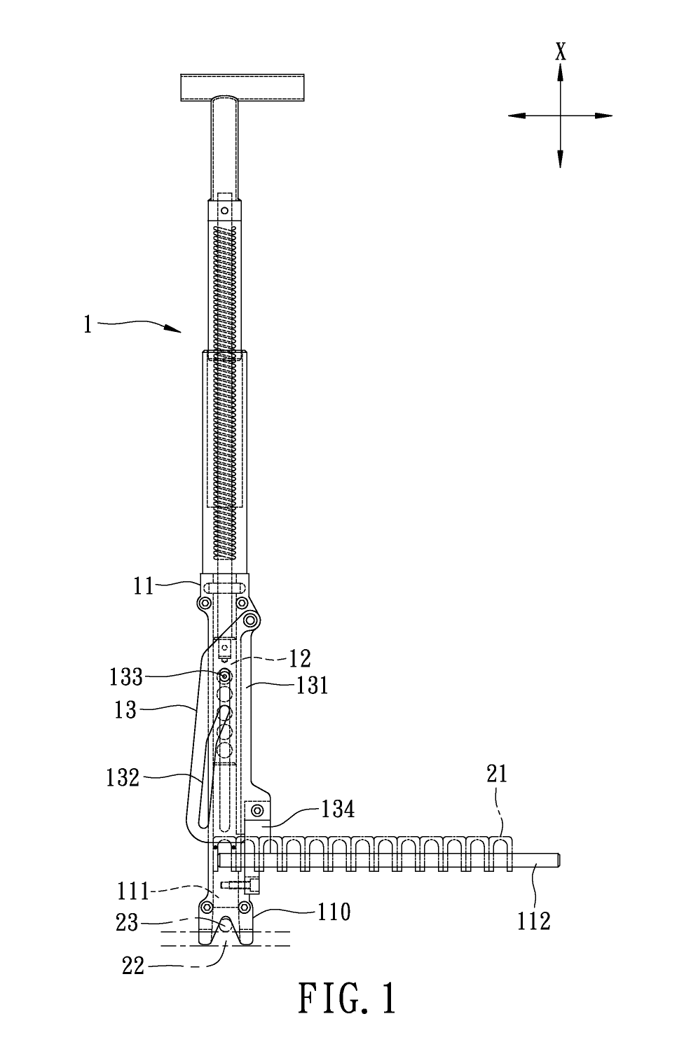

FIG. 2 is a perspective view of a clip used in the conventional bar connecting apparatus;

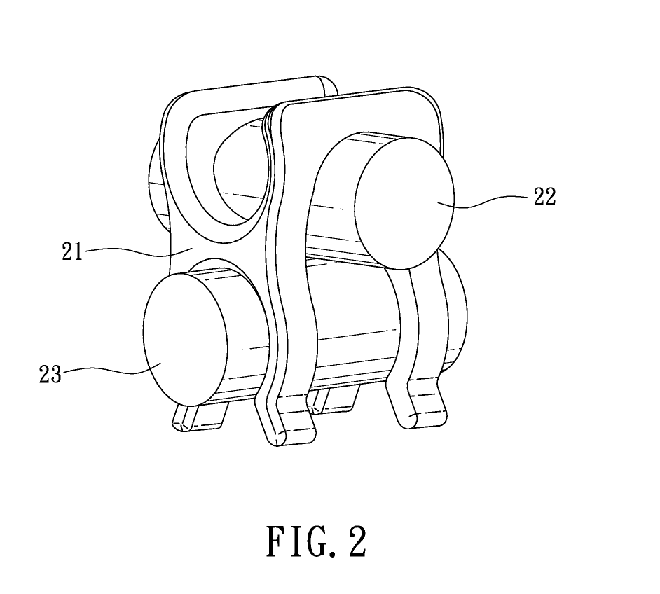

FIG. 3 is a side view of the preferred embodiment of an assembly of a bar connecting apparatus and a string of clips according to this invention;

FIG. 4 is a schematic view of the string of the clips of the preferred embodiment;

FIG. 5 is a perspective view of one of the clips of the preferred embodiment;

FIG. 6 is a sectional view taken along line VI-VI in FIG. 3;

FIG. 7 is an exploded perspective view of a magazine unit of the preferred embodiment;

FIG. 8 is a sectional view taken along line VIII-VIII in FIG. 3;

FIG. 9 is a side view of the preferred embodiment, illustrating a first position of a second safety member;

FIG. 10 is a perspective view illustrating how to interconnect two intersecting bars by one of the clips of the preferred embodiment; and

FIG. 11 is a side view of the preferred embodiment, illustrating a second position of the second safety member.

### DETAILED DESCRIPTION OF THE PREFERRED EMBODIMENT

Before the present invention is described in greater detail in connection with the preferred embodiments, it should be noted that similar elements and structures are designated by like reference numerals throughout the entire disclosure.

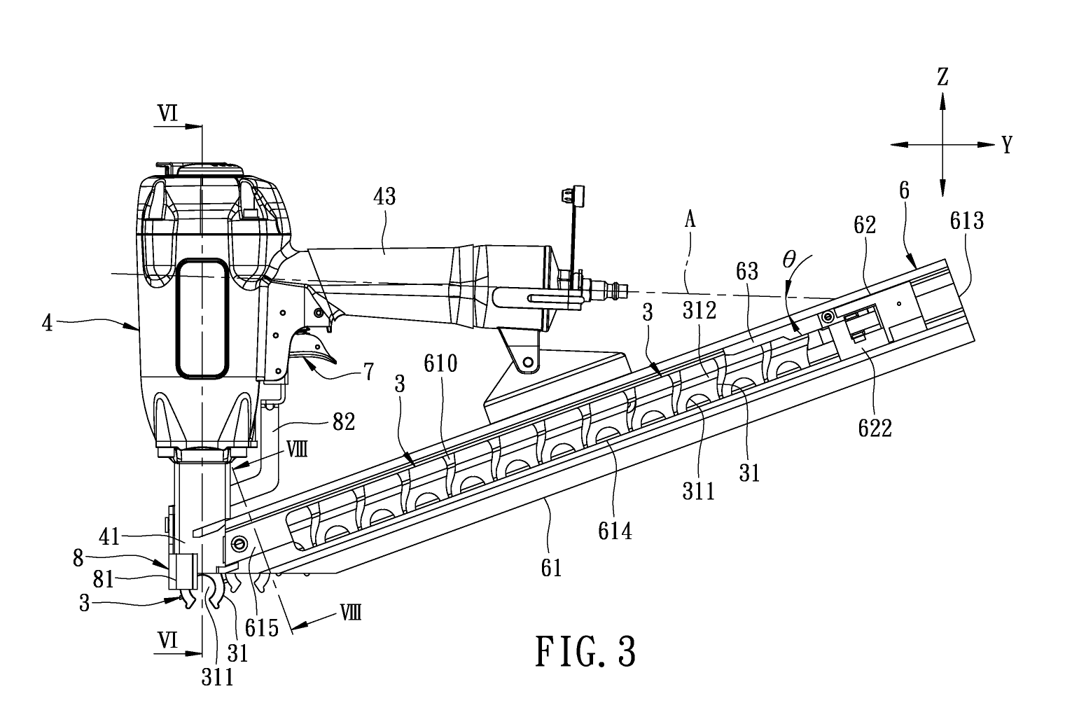

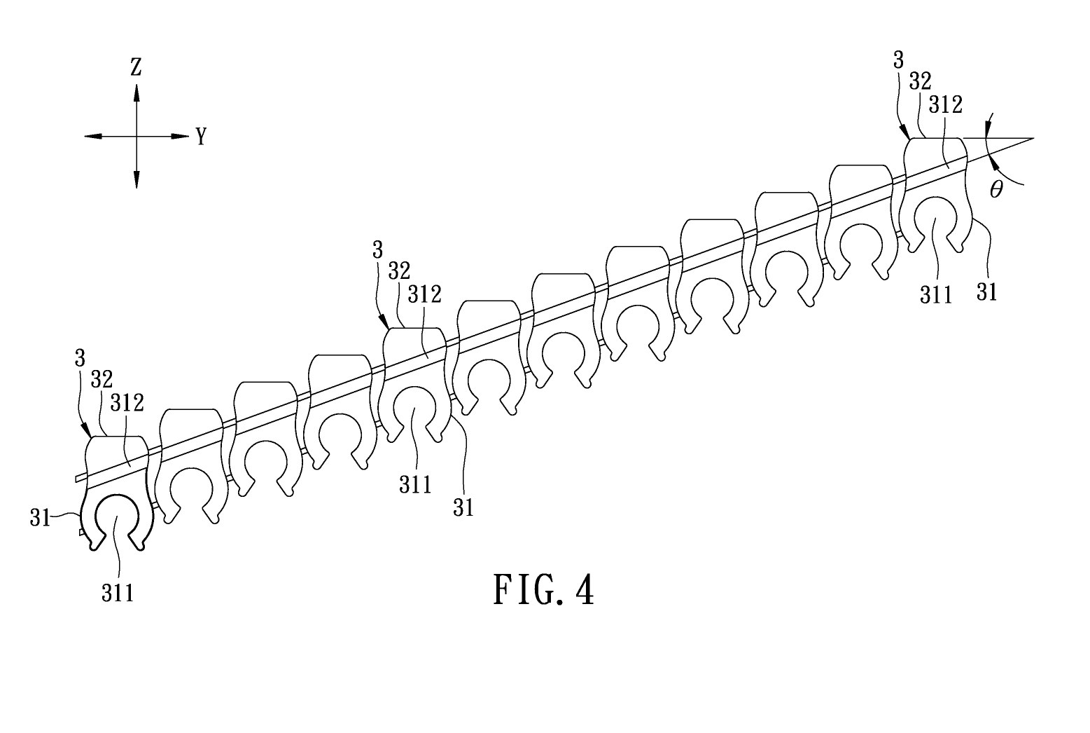

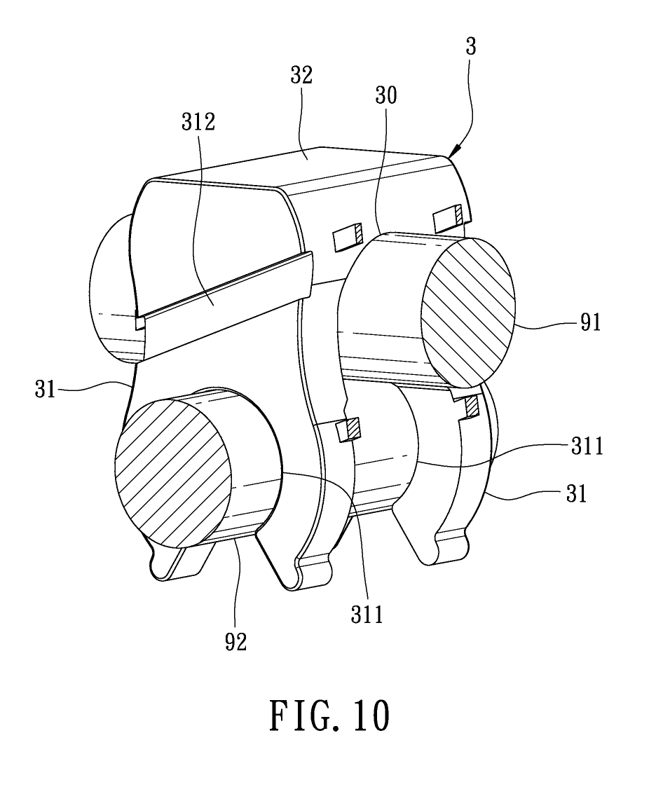

FIGS. 3, 4, and 5 show the preferred embodiment of an assembly of a bar connecting apparatus and a string of clips according to this invention. The bar connecting apparatus is used for firing one of a string of clips 3 to interconnect first and second bars 91, 92 (see FIG. 10) that intersect each other.

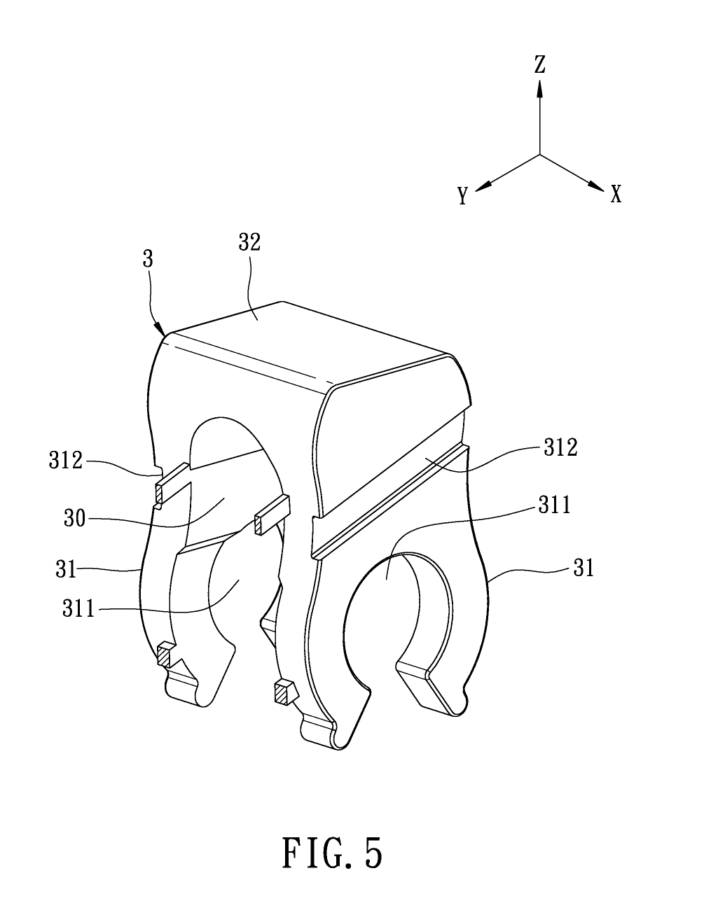

One of the clips 3 is described in this paragraph. With particular reference to FIG. 5, the clip 3 includes two jaws 31 spaced apart from and aligned with each other along an X-axis direction, and a bridge 32 interconnecting the jaws 31. Each of jaws 31 defines a small notch 311, and has a slide slot 312 formed in an outer side surface thereof and extending along an inclined direction inclined relative to the X-axis direction. The small notches 311 are for receiving the second bar 92 such that the second bar 92 extends along the X-axis direction. The bridge 32 cooperates with the jaws 31 to define a large notch 30 thereamong for receiving the first and second bars 91, 92, such that the first bar 91 extends along a Y-axis direction perpendicular to the X-axis direction.

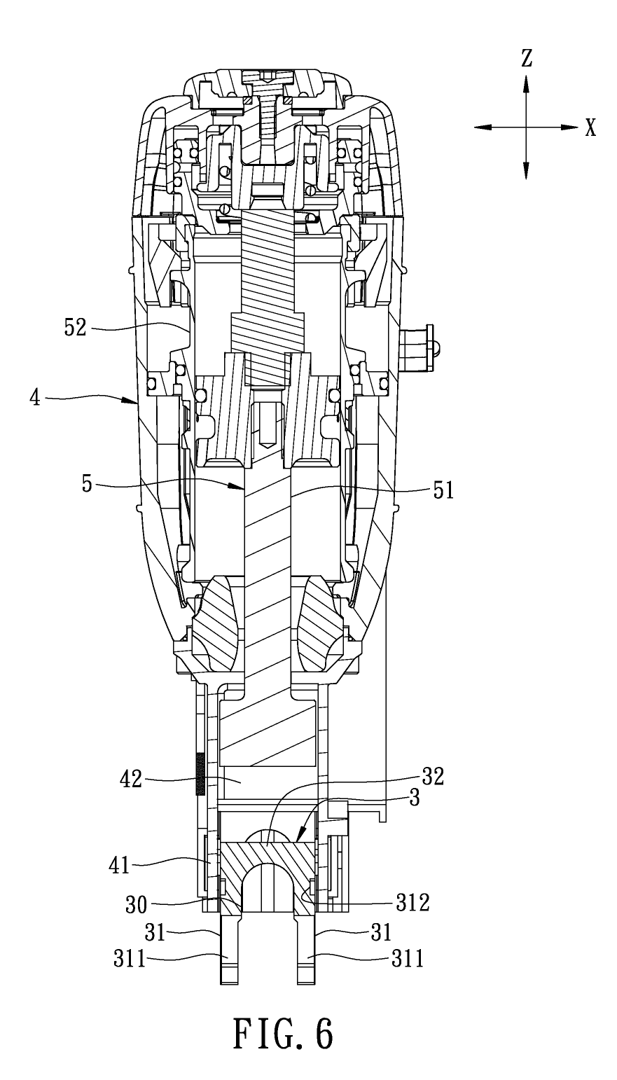

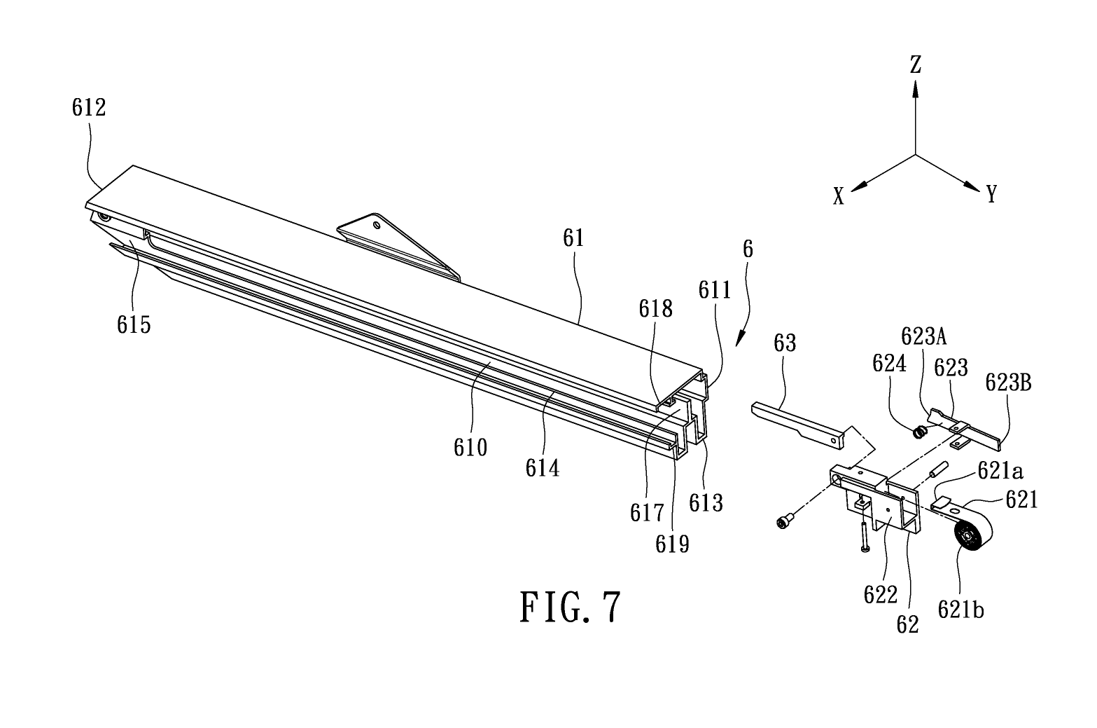

With further reference to FIGS. 6 and 7, the bar connecting apparatus includes a main body 4, a driving unit 5, a magazine unit 6, a trigger unit 7, and a safety unit 8.

The main body 4 has a front end portion 41 formed with an elongated ejection opening 42, and a handle portion 43 adjacent to a rear end thereof and extending along a handle axis (A) (see FIG. 3) parallel to the Y-axis direction. In other words, the handle portion 43 extends along the Y-axis direction.

The driving unit 5 includes a hammer 51 extends in the main body 4 along a Z-axis direction perpendicular to the X-axis direction and the Y-axis direction, and a drive 52 disposed in the main body 4 for reciprocating the hammer 51. In this embodiment, the drive 52 is an air cylinder.

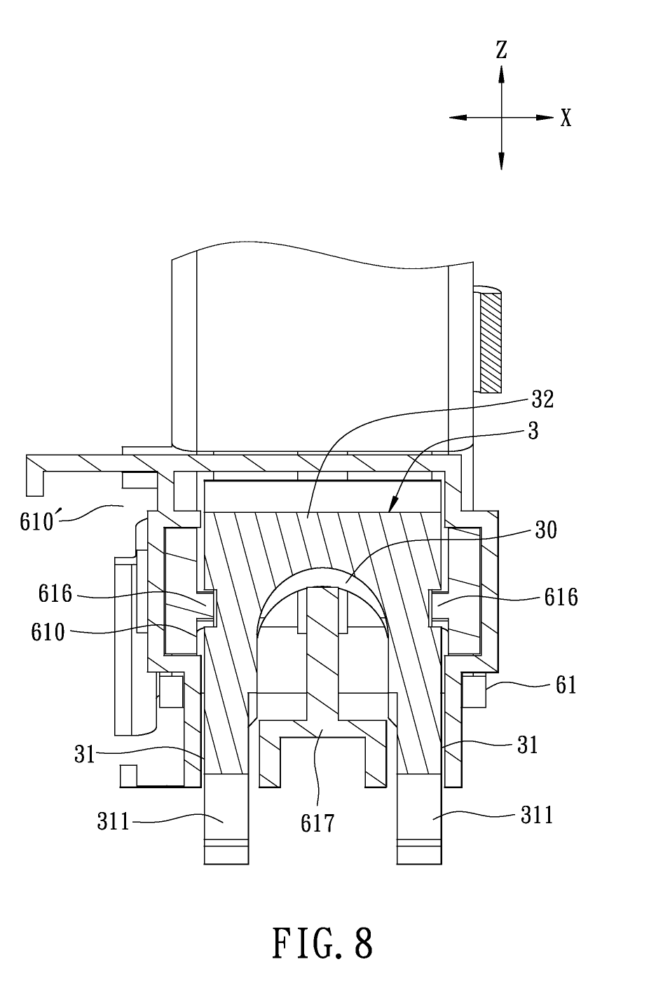

With particular reference to FIGS. 3, 7, and 8, the magazine unit 6 includes a magazine 61 for storing the clips 3, a clip pushing device 62, and a safety protrusion 63. The magazine 6 includes: a wall 611 defining a clip passage 610 and having a front end 612 proximate to the ejection opening 42 in the main body 4, and a rear end 613 opposite to the front end 612 and adjacent to the handle portion 43 of the main body 4; an elongated opening 614 formed in a side of the wall 611 such that the clip passage 610 is exposed in the elongated opening 614; a side wing 615 formed integrally with the wall 611, sealing a portion of the elongated opening 614, and adjacent to the ejection opening 42 in the main body 4, two guide rails 616 extending respectively and inwardly from the wall 611 and the side wing 615; a position-limiting portion 617 extending in and along the clip passage 610; an upper track 618 configured as an L-shaped projection, extending from a top end of the wall 611, and adjacent to the elongated opening 614; and a lower track 619 configured as an L-shaped projection, extending from the wall 611 at a position adjacent to the lower end of the wall 611, and disposed under the upper track 618 to cooperate with the upper track 618 to define a block receiving slot 610′ (see FIG. 8) therebetween, which is in spatial communication with the clip passage 610. The clip passage 610 extends along the inclined direction, and forms an angle θ (see FIG. 3) with respect to the handle axis (A). That is, the clip passage 610 is inclined relative to the Y-axis direction, and the clips 3 are arranged along the inclined direction. The clips 3 are received within the clip passage 610, and straddle the position-limiting portion 617. The clip pushing device 62 includes a spiral spring 621 disposed in the clip passage 610 in the magazine 61, a sliding block 622 disposed movably in the block-receiving slot 610′, such that the spiral spring 621 is disposed above the sliding block 622, a seesaw member 623 disposed pivotally on the sliding block 622 and between the sliding block 622 and the position-limiting portion 617 and having a clip-pushing end 623A for pushing the string of the clips 3, and a finger-operated end 623B opposite to the clip-pushing end 623A and projecting from the sliding block 622; and a coiled compression spring 624 disposed between the seesaw member 623 and the sliding block 622 for biasing the clip-pushing end 623A away from the sliding block 622 to a pushing position whereat the clip-pushing end 623A is engaged in the clip passage 610. The finger-operated end 623B is operable to pivot the clip-pushing end 623A to a non-pushing position whereat the clip-pushing end 623A is disengaged from the clip passage 610. The spiral spring 621 has a fixed end 621a fastened to the magazine 61 and adjacent to the front end 612 of the magazine 61, and a connecting end 621b connected fixedly to the sliding block 622. The safety protrusion 63 is formed on the sliding block 622 of the clip pushing device 62. One of the clips 3 closest to the main body 4 (i.e., the terminal clip 3) is pushed by the pushing block 62 into the ejection opening 42 in the main body 4, such that a portion thereof extends outwardly from the main body 4 through the ejection opening 42, as shown in FIG. 3.

The trigger unit 7 is disposed on the main body 4 for controlling airflow into the drive 52.

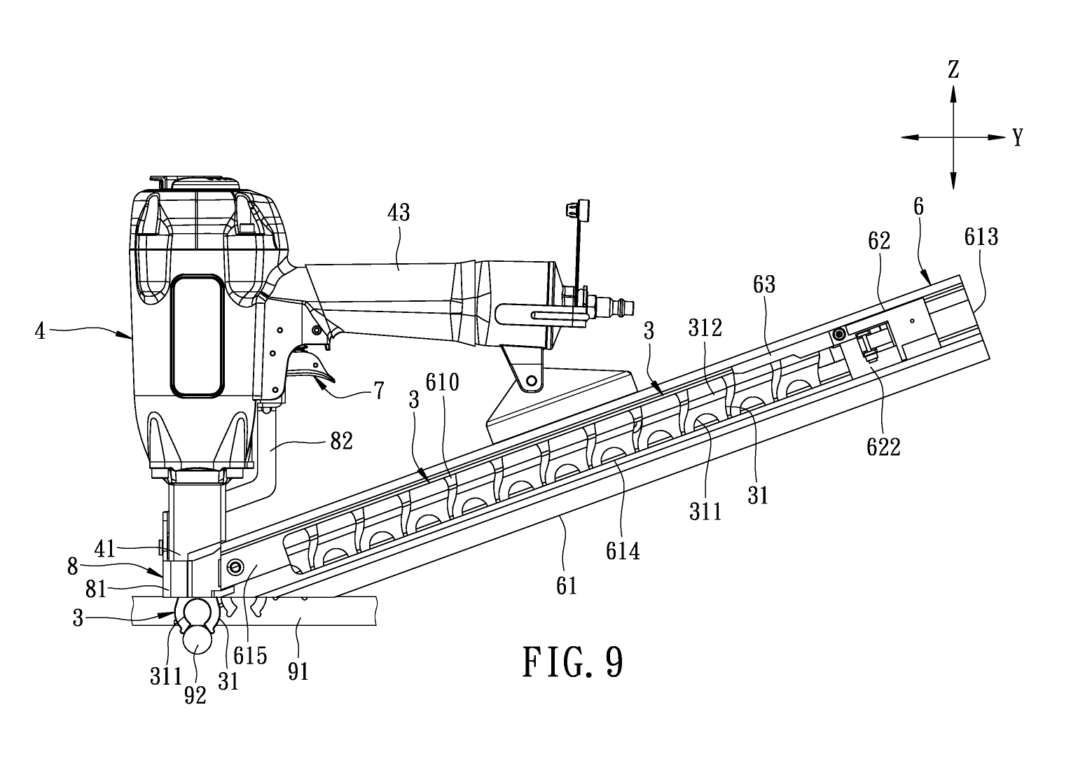

The safety unit 8 includes a first safety member 81 movable on said main body 4 and projecting partially and forwardly from the front end portion 41 of the main body 4, and a second safety member 82 connected to the first safety member 81. The second safety member 82 is movable between a first position shown in FIG. 9 and a second position shown in FIG. 3 in response to movement of the first safety member 81 relative to the main body 4. When the second safety member 82 is disposed at the first position, actuation of the trigger unit 7 is allowed. When the second safety member 82 is disposed at the second position, actuation of the trigger unit 7 is prevented.

With particular to FIGS. 3, 7, and 8, when filling of the string of the clips 3 is desired, the string is put into the clip passage 610 through the rear end 613 of the magazine 61. As soon as the string comes into contact with the seesaw member 623, it presses the clip-pushing end 623A to the non-pushing position. Subsequently, an external force is applied to push the sliding block 622 of the clip pushing device 62 to the rear end 613 of the magazine 61. When the sliding block 622 reaches the rear end 613 of the magazine 61, the seesaw member 623 is removed from the string. At this time, since the clip-pushing end 623A of the seesaw member 623 is no longer pressed, it is biased by the coiled compression spring 624 to the pushing position (i.e., into the clip passage 610), and thus is biased by the spiral spring 621 to press against the last clip 3.

With reference to FIGS. 6, 8, and 9, when the terminal clip 3 is to be fired, since a portion of the terminal clip 3 projects from the ejection opening 42, it is only necessary to engage the first bar 91 with the large notch 30 and align the jaws 31 with the second bar 92 (i.e., allow the small notches 311 to be opened toward the second bar 92) prior to operation of the safety unit 8. During operation of the safety unit 8, the first safety member 81 is pressed against the first bar 91 to move the second safety member 82 to the first position in a direction toward the handle portion 43, thereby allowing for actuation of the trigger unit 7.

When the trigger unit 7 is actuated, compressed air is forced into the drive 52 to generate a kinetic energy to move the hammer 51 toward the ejection opening 42 to strike the terminal clip 3, thus ejecting the terminal clip 3 out of the ejection opening 42 along the Z-axis direction. At this time, the sliding block 622 is biased by the spiral spring 621 to push the string of the remaining clips 3 to move along the clip passage 610 toward the ejection opening 42 until the next clip 3 is moved into the ejection opening 42 and becomes the terminal clip 3. During movement of the string of the clips 3, by guiding action of the position-limiting portion 617, the string can advance along a straight path. Furthermore, when the string moves past the side wing 615, due to engagement of the guide rails 616 in the inner surfaces of the side wing 615 and the wall 611 with the slide slots 312 in the jaws 31, the terminal clip 3 can move accurately to a stand-by position in the ejection opening 42.

With particular reference to FIG. 10, when the terminal clip 3 is fired, it grasps the second bar 92 by engaging the the second bar 92 with the small notches 311 in a close fitting manner, thereby interconnecting the first and second bars 91,92.

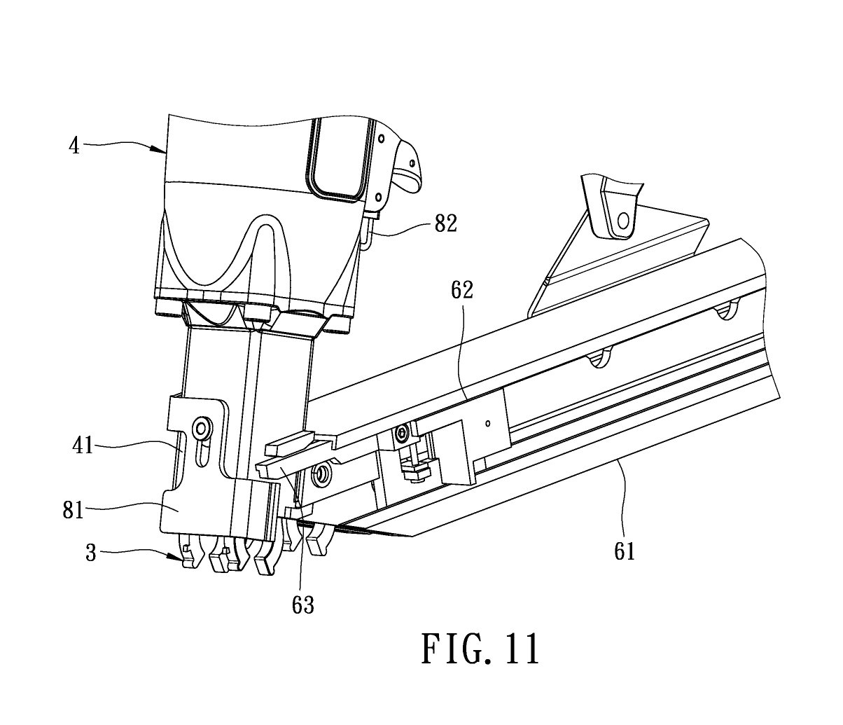

With particular reference to FIG. 11, when the number of the clips 3 in the string is reduced to a predetermined number, e.g., two, the sliding block 622 is spaced apart from the front end portion 41 of the main body 4 by a small distance, such that the safety protrusion 63 is in contact with and disposed behind the first safety member 81, so as to obstruct the first safety member 81 from rearward movement, thereby retaining the second safety member 82 at the second position. At this time, when the first safety member 81 is pressed against the first bar 91, it cannot move relative to the main body 4. As a consequence, the user can realize that the clips 3 in the magazine 61 are to be consumed.

In view of the above, the assembly of the bar connecting apparatus and the clip string of this invention has the following advantages:

1. It is noted that, each of the clips 3 has a variable width in a Y-axis direction. Since the clips 3 are arranged along the inclined direction, the maximum-width portions of the clips 3 are misaligned from each other along the Y-axis direction, so that the number of the clips 3 in a magazine 61 having a predetermined length can be increased.

2. The first safety member 81 covers partially the portion of the terminal clip 3 projecting from the ejection opening 42. As such, the first bar 91 can be engaged into the large notch 30 of the terminal clip 3 just before the terminal clip 3 is fired, thereby allowing for convenient and accurate alignment of the terminal clip 3 with the first and second bars 91, 92.

With this invention thus explained, it is apparent that numerous modifications and variations can be made without departing from the scope and spirit of this invention. It is therefore intended that this invention be limited only as indicated by the appended claims.

We claim:

1. A bar connecting apparatus for firing a string of clips one at a time to connect two intersecting bars together, said bar connecting apparatus comprising:
a main body having a front end portion formed with an ejection opening;
a driving unit including a hammer disposed in said main body, and a drive disposed in said main body for reciprocating said hammer; and
a magazine unit including a magazine connected to said main body and adapted for storing the clips, and a clip pushing device disposed in said magazine and adapted for pushing one of the clips into said ejection opening so that a portion of the one of the clips extends outwardly from said main body through said ejection opening.

2. The bar connecting apparatus as claimed in claim 1, each of the clips having two slide slots formed respectively in two opposite sides thereof, wherein said magazine has a clip passage adapted for receiving the clips, and two guide rails adapted to be engaged respectively and movably within the slide slots in each of the clips.

3. The bar connecting apparatus as claimed in claim 2, wherein said magazine further has a wall defining said clip passage, an elongated opening formed in a side of said wall such that said clip passage is exposed in said elongated opening, and a side wing formed integrally with said wall, sealing a portion of said elongated opening, and adjacent to said ejection opening in said main body, said guide rails extending respectively from said wall and said side wing.

4. The bar connecting apparatus as claimed in claim 3, wherein said magazine further has a position-limiting portion extending in and along said clip passage and adapted to permit the clips to straddle said position-limiting portion.

5. The bar connecting apparatus as claimed in claim 1, wherein said magazine has a front end adjacent to said ejection opening in said man body, and a rear end opposite to said front end, said clip pushing device including a spiral spring and a sliding block, said spiral spring having a fixed end fastened to said magazine and adjacent to said front end of said magazine, and a connecting end connected fixedly to said sliding block, said sliding block being disposed movably in said clip passage and being adapted to be biased to press against the last one of the clips to urge the clips toward said ejection opening.

6. The bar connecting apparatus as claimed in claim 1, further comprising a trigger unit and a safety unit, said safety unit including a first safety member movable on said main body and projecting partially and forwardly from said front end portion of said main body, and a second safety member connected to said first safety member, said second safety member being movable between first and second positions in response to movement of said first safety member relative to said main body such that, when said second safety member is disposed at the first position, actuation of said trigger unit is allowed, and when said second safety member is disposed at the second position, actuation of said trigger unit is prevented.

7. The bar connecting apparatus as claimed in claim 6, wherein said first safety member is adapted for covering at least partially one of the clips disposed within said ejection opening such that one of the bars contacted first by said first safety member moves said first safety member and, thus, said second safety member relative to said main body.

8. The bar connecting apparatus as claimed in claim 6, wherein said magazine unit further includes a safety protrusion formed on said clip pushing device and movable to contact and retain said second safety member at the second position.

9. The bar connecting apparatus as claimed in claim 1, wherein said ejection opening is positioned to permit the one of the clips to ejected therefrom along a Z-axis direction, said main body further having a handle portion extending along a Y-axis direction perpendicular to the Z-axis direction, said magazine being further adjacent to said handle portion, said clip passage extending in an inclined direction inclined relative to the Z-axis and Y-axis directions to allow the clips to be arranged along the inclined direction.

10. The bar connecting apparatus as claimed in claim 9, each of the clips having two slide slots formed respectively in two opposite sides thereof, wherein said magazine has a clip passage adapted for receiving the clips, and two guide rails extending along the inclined direction and adapted to be engaged respectively and movably within the slide slots in each of the clips.

11. The bar connecting apparatus as claimed in claim 1, each of the clips has two jaws each defining a small notch, a bridge interconnecting the jaws to define a large notch defined thereamong, wherein said ejection opening is configured to allow said portion of the one of the clips extending outwardly from said main body through said ejection opening to be moved to engage one of the bars within the large notch, such that the small notches of the jaws are opened toward the other of the bars.

12. A string of clips adapted to be disposed in a bar connecting apparatus, the bar connecting apparatus interconnecting two intersecting bars and including a main body, the main body having an ejection opening permitting one of said clips to be ejected therefrom along a Z-axis direction, and a handle portion extending along a Y-axis direction perpendicular to the Z-axis direction, each of said clips comprising:
two jaws spaced apart from and aligned with each other along an X-axis direction perpendicular to the Y-axis direction and the Z-axis direction, each of said jaws defining a small notch and being formed with a slide slot extending along an inclined direction that is inclined relative to the X-axis direction and the Y-axis direction, said small notches of said jaws being adapted for receiving one of the bars; and
a bridge interconnecting the jaws to define a large notch defined thereamong and receiving the bars.

13. The string of clips as claimed in claim 12, wherein said clips are arranged along the inclined direction.
